(19) United States
(12) Patent Application Publication
(10) Pub. No.: US 2025/0298345 A1
(43) Pub. Date: Sep. 25, 2025

(54) IMAGE FORMING APPARATUS

(71) Applicant: CANON KABUSHIKI KAISHA, Tokyo (JP)

(72) Inventor: SHIGEKI TAKISHITA, Ibaraki (JP)

(21) Appl. No.: 19/082,892

(22) Filed: Mar. 18, 2025

(30) Foreign Application Priority Data
Mar. 19, 2024 (JP) 2024-044262

(51) Int. Cl. G03G 15/16

(52) U.S. Cl. CPC G03G 15/1615; G03G 15/1675; G03G 15/1695

(57) ABSTRACT

An image forming apparatus includes an image bearing member, an intermediary transfer belt, an inner roller, a secondary transfer member, a first applying portion for applying, to the inner roller, a secondary transfer bias of the same polarity as a normal charge polarity of toner, a recording material charging member provided upstream of a secondary transfer portion with respect to a recording material conveying direction so as to contact a surface of a recording material on a side opposite from a surface of the recording material which is conveyed toward the secondary transfer portion and onto which the toner image is transferred and for charging the recording material, and a second applying portion for applying, to the recording material charging member, a recording material charging bias of the same polarity as the polarity of the secondary transfer bias.

### FIELD OF THE INVENTION AND RELATED ART

The present invention relates to an image forming apparatus, such as a copying machine, a printer, a facsimile machine, or a multi-function machine having a plurality of functions of these machines, using an electrophotographic type or an electrostatic recording type.

Conventionally, for example, as the image forming apparatus such as the copying machine using the electrophotographic type, there is an image forming apparatus of an intermediary transfer type. In the image forming apparatus of the intermediary transfer type, a toner image formed on an image bearing member is primarily transferred onto an intermediary transfer member in a primary transfer portion, and then the toner image onto the intermediary transfer member is secondarily transferred onto a recording material such as paper in a secondary transfer portion. As the intermediary transfer member, an intermediary transfer belt constituted by an endless belt stretched by a plurality of stretching rollers is used in many cases.

In such an image forming apparatus, depending on specifications of the recording material or the like, there is a possibility that image deterioration such as transfer void due to insufficient transfer current occurs. For example, in the case where in a low-humidity environment, a toner image is transferred onto a recording material high in electric resistance or in the like case, there is a possibility that an absolute value of a voltage of a secondary transfer bias for passing a necessary transfer current exceeds a high-voltage capacitance and thus the transfer void due to the insufficient transfer current occurs.

In Japanese Patent Publication No. 3517621, it is proposed that a surface of a recording material onto which a toner image is transferred is electrically charged tan opposite polarity to a normal charge polarity of toner in advance before the recording material reaches a secondary transfer portion.

Recently, for example, in a production machine of the intermediary transfer type, there is a tendency that a kind of the recording material used for image formation increases. For example, in order to secondarily transfer appropriately the toner image onto the recording material high in electric resistance, such as synthetic paper (recording material comprising plastic as a main component) or ultra-thick paper (thick paper having a basis weight exceeding 250 gsm), there is a need to apply a secondary transfer bias very large in absolute value of a voltage. In order to secondarily transfer appropriately the toner image onto such a recording material without lowering productivity (image forming speed), it is effective that insufficient transfer current is made up for by charging a surface of the recording material, onto which the toner image is transferred, to an opposite polarity to the normal charge polarity of the toner in advance.

Here, it is desirable that a pre-charging portion (recording material charging portion) for pre-charging the surface of the recording material onto which the toner image is transferred is close to the secondary transfer portion to the extent possible. With an increasing distance from the secondary transfer portion, a charge amount of the surface on which the toner image is transferred is attenuated, so that an effect of making up for the insufficient transfer current becomes small. However, when the pre-charging portion is made close to the secondary transfer portion, a current flows between the secondary transfer portion and the pre-charging portion through the recording material (a transfer current and a pre-charging current interfere with each other), so that there is a possibility that in conveniences such that a necessary transfer current cannot be obtained and thus improper transfer occurs are caused.

### SUMMARY OF THE INVENTION

A principal object of the present invention is to enable that a recording material is electrically charged effectively between a secondary transfer portion and a recording material charging portion by suppressing a flow of a current between the secondary transfer portion and the recording material charging portion.

This object is accomplished by an image forming apparatus according to the present invention.

According to an aspect of the present invention, there is provided an image forming apparatus comprising: an image bearing member configured to bear a toner image; an intermediary transfer belt onto which the toner image is primarily transferred from the image bearing member; an inner roller configured to form a secondary transfer portion, where the toner image is transferred from the intermediary transfer belt onto a recording material, in contact with an inner surface of the intermediary transfer belt; a secondary transfer member configured to form the secondary transfer portion in contact with an outer peripheral surface of the intermediary transfer belt and in cooperation with the inner roller; a first applying portion configured to apply, to the inner roller, a secondary transfer bias of the same polarity as a normal charge polarity of toner; a recording material charging member provided upstream of the secondary transfer portion with respect to a recording material conveying direction so as to contact a surface of the recording material on a side opposite from a surface of the recording material which is conveyed toward the secondary transfer portion and onto which the toner image is transferred; and a second applying portion configured to apply, to the recording material charging member, a recording material charging bias of the same polarity as the polarity of the secondary transfer bias.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic sectional view of an image forming portion.

FIG. 3 is a black diagram showing an outline of a control constitution of the image forming apparatus.

FIG. 4 is a schematic sectional view of a neighborhood of a secondary transfer portion in an image forming apparatus of an embodiment 1.

FIG. 5 is a schematic sectional view of a neighborhood of a secondary transfer portion in an image forming apparatus of a comparison example 1-2.

FIG. 6 is a schematic sectional view of a neighborhood of a secondary transfer portion in an image forming apparatus of an embodiment 2.

FIG. 7 is a schematic sectional view of a neighborhood of a secondary transfer portion in an image forming apparatus of a comparison example 2.

FIG. 8 is a schematic sectional view of a neighborhood of a secondary transfer portion in an image forming apparatus of an embodiment 2.

FIG. 9 is a schematic sectional view of a neighborhood of a secondary transfer portion in an image forming apparatus of a comparison example 3.

### DESCRIPTION OF EMBODIMENTS

An image forming apparatus according to the present invention will be specifically described with reference to the drawings.

### Embodiment 1

### 1. Constitution and Operation of Image Forming Apparatus

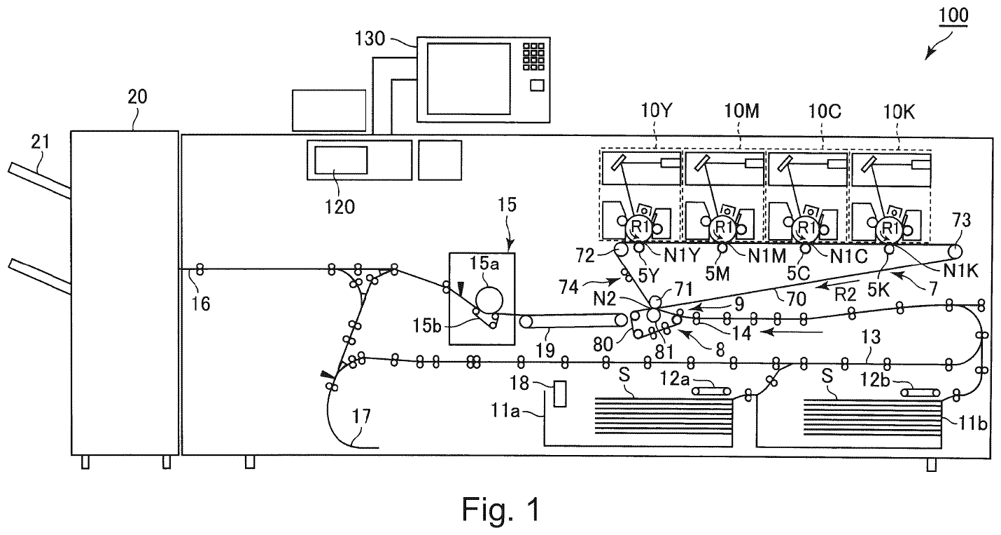

FIG. 1 is a schematic sectional view of an image forming apparatus 100 of an embodiment 1. The image forming apparatus 100 in this embodiment is a tandem full-color printer which is capable of forming a full-color image with use of an electrophotographic type and which employs an intermediary transfer type. The image forming apparatus 100 is capable of forming and outputting an image on a sheet-like recording material on the basis of image information inputted from an external device such as a personal computer or image information inputted through an operating portion 130 provided to the image forming apparatus 100, or the like. Incidentally, in the image forming apparatus 100, paper is principally used as a recording material, and therefore, the recording material S is referred to as paper in some instances, but the recording material S is not limited to the paper. As the recording material S, for example, it is also possible to use, for example, recording materials constituted by materials other than paper or materials containing the materials other than the paper, such as a synthetic paper or a film constituted by a material principally comprising a synthetic resin, and special paper such as metallized paper having a metal layer, and the like.

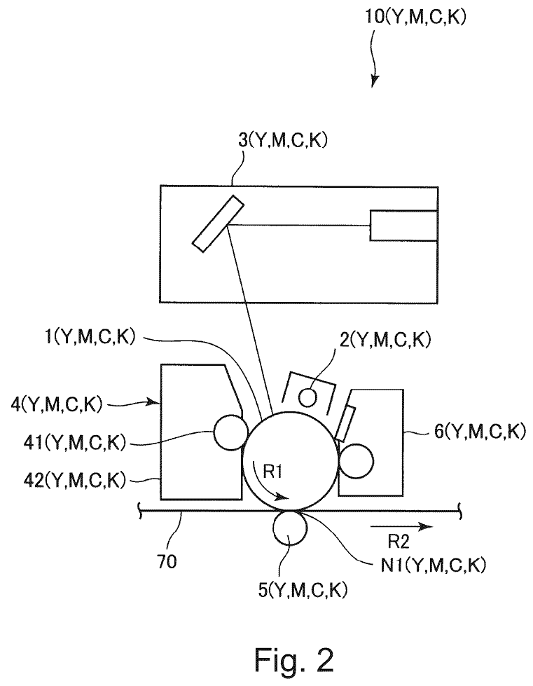

The image forming apparatus 100 includes four image forming portions 10Y, 10M, 10C and 10K for forming color images of yellow (Y), magenta (M), cyan (C) and black (K). The respective image forming portions 10Y, 10M, 10C, and 10K are linearly arranged along a movement direction of an image transfer surface of an intermediary transfer belt 70 provided substantially horizontally as described later. Incidentally, as regards elements provided for respective colors, and having the same or corresponding functions or constitutions, suffixes Y, M, C and K for representing the elements for associated colors are omitted, and the elements will be collectively described in some instances. In this embodiment, the image forming portion 10 is constituted by including a photosensitive drum 1, a charging device 2, an exposure device 3, a developing device 4, a drum cleaning device 6, and the like, which are described later. FIG. 2 is a schematic sectional view of the image forming portion 10.

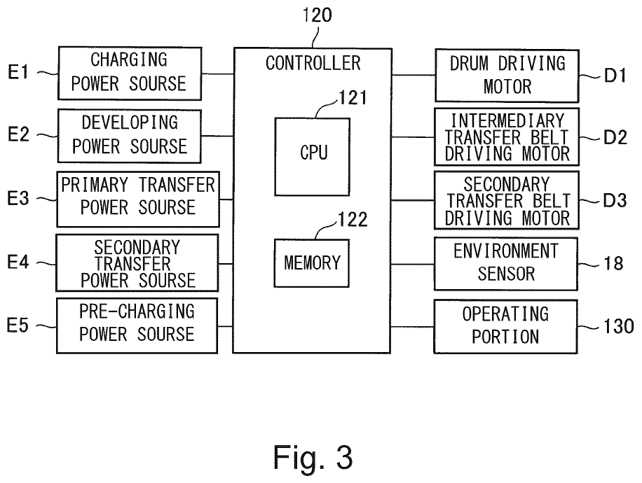

The photosensitive drum 1 which is a drum-type (cylindrical) photosensitive drum 1 as an image bearing member is movable (rotatable) while carrying an electrostatic image (electrostatic latent image). The photosensitive drum 1 includes an aluminum cylinder as a substrate and a surface layer (photosensitive layer) formed on a surface thereof. When an image forming operation is started, the photosensitive drum 1 is rotationally driven at a predetermined peripheral speed (process speed) in an arrow R1 direction (counterclockwise direction) by drum a driving motor D1 (FIG. 3) as a driving means. A surface of the rotating photosensitive drum 1 is electrically charged uniformly to a predetermined polarity (negative polarity in this embodiment) and a predetermined potential by the charging device 2 as a charging means. In this embodiment, the charging device 2 is a scorotron charger provided opposed to the photosensitive drum 1. During the charging, to a charging wire of the charging device 2, a predetermined charging bias (charging voltage) is applied by a charging power source E1 (FIG. 3) as a charging voltage applying means (charging voltage applying portion). By this, the charging device 2 causes electric discharge, and electrons generated by this discharge charge the surface of the photosensitive drum 1. The charged surface of the photosensitive drum 1 is subjected to scanning exposure to light on the basis of image information (image signal) by the exposure device 3 as an exposure means, so that an electrostatic image is formed on the photosensitive drum 1. In this embodiment, the exposure device 3 is a laser scanner. The exposure device 3 emits laser light in accordance with image information of separated color outputted from a controller 120 (FIG. 3), and subjects the surface (outer peripheral surface) of the photosensitive drum 1 to the scanning exposure.

The electrostatic image formed on the photosensitive drum 1 is developed (visualized) by being supplied with toner as a developer by the developing device 104 as a developing means, so that a toner image (toner picture, developer image) is formed on the photosensitive drum 1. In this embodiment, the developing device 4 develops the electrostatic image with a two-component developer, as a developer, provided with non-magnetic toner particle (toner) and magnetic carrier particles (carrier). The developing device 4 includes a developing sleeve 41 as a developer carrying member (developing member) and a developing container 42 for accommodating the developer. The developing sleeve 41 carries the developer in the developing container 42 and then conveys the developer toward a developing region opposing the photosensitive drum 1. During the development, to the developing sleeve 41, a predetermined developing bias (developing voltage) is applied by a developing power source E2 (FIG. 3) as a developing voltage applying means (developing voltage applying portion). In this embodiment, the toner charged to the same polarity as a charge polarity (negative polarity in this embodiment) of the photosensitive drum 1 is deposited on an exposed portion (image portion) of the photosensitive drum 1 where an absolute value of the potential is lowered by exposing the surface of the photosensitive drum 1 to light after the photosensitive drum 1 is uniformly charged (reverse development type). In this embodiment, a normal charge polarity of toner which is a principal charge polarity of the toner during the development is a negative polarity.

An intermediary transfer unit 7 is provided so as to oppose the four photosensitive drums 1Y, 1M, 1C, and 1K. The intermediary transfer unit 7 is constituted by including the intermediary transfer belt 70, an inner secondary transfer roller 71, a driving roller 72, a tension roller 73, primary transfer rollers 5Y, 5M, 5C, and 5K, and the like. The intermediary transfer belt 70 constituted as an intermediary transfer member by an endless belt is movable (rotatable) while carrying a toner image. The intermediary transfer belt 70 is extended around and stretched at a predetermined tension by, as a plurality of stretching rollers (supporting rollers), the inner secondary transfer roller 71, the driving roller 72, and the tension roller 73. The driving roller 72 is rotationally driven by an intermediary transfer belt driving motor D2 (FIG. 3) as a driving means. To the intermediary transfer belt 70, a driving force is transmitted by the driving roller 72, and the intermediary transfer belt 70 is rotated (circumferential movement) in an arrow R2 direction (counterclockwise direction) in FIG. 1 at a predetermined peripheral speed (process speed) corresponding to the peripheral speed of the photosensitive drum 1. The tension roller 73 imparts a predetermined tension to the intermediary transfer belt 70. The inner secondary transfer roller 71 forms a secondary transfer portion N2 in a cooperation with an outer secondary transfer roller 81 described later. On the inner peripheral surface side of the intermediary transfer belt 70, the primary transfer rollers 5Y, 5M, 5C, and 5K which are roller-type primary transfer members as primary transfer means are disposed correspondingly to the respective photosensitive drums 1Y, 1M, 1C, and 1K. The primary transfer roller 5 presses the intermediary transfer belt 70 toward an associated photosensitive drum 1, whereby a primary transfer portion (primary transfer nip) N1 where the photosensitive drum 1 and the intermediary transfer belt 70 contact each other is formed. The stretching rollers, for the intermediary transfer belt 70, other than the driving roller 72, and the respective primary transfer rollers 5 are rotated with rotation of the intermediary transfer belt 70.

The toner image formed on the photosensitive drum 1 is transferred (primarily-transferred) onto the rotating intermediary transfer belt 7 as a toner image receiving member in the primary transfer portion N1 by the action of the primary transfer roller 5. During the primary transfer, to the primary transfer roller 5, a primary transfer bias (primary transfer voltage) which is a DC voltage of an opposite polarity (positive polarity in this embodiment) to the normal charge polarity of the toner is applied by a primary transfer power source E3 (FIG. 3) as a primary transfer voltage applying means (primary transfer voltage applying portion). To the primary transfer roller 5, the primary transfer bias of the positive polarity is applied, whereby the toner image formed of the toner of the negative polarity on the photosensitive drum 1 is transferred onto the intermediary transfer belt 70. For example, during full-color image formation, the color toner images of yellow, magenta, cyan, and black formed on the respective photosensitive drums 1 are successively transferred superposedly onto the intermediary transfer belt 70, so that a multiple toner image is formed on the intermediary transfer belt 70.

Here, in this embodiment, the primary transfer roller 5 includes a core metal and an elastic layer formed with an ion-conductive foamed rubber (NBR rubber (nitrile rubber)) and ECO rubber (epichlorohydrin rubber) so as to coat an outer periphery of the core metal. An outer diameter of the primary transfer roller 5 is, for example, 15-20 mm. Incidentally, herein, as regards numerical value ranges, “-” means that numerical values before and after “-” are included in the associated numerical value range. Further, as the primary transfer roller 5, a roller having an electric resistance value of 1×10⁵-1×10⁸Ω measured in N/N (23° C./50% RH) environment under application of a voltage of 2 kV may suitably be used.

Further, in this embodiment, the intermediary transfer belt 70 is constituted by an endless belt having a three-layer structure of a base layer, an elastic layer, and a surface layer from the inner peripheral surface side. As a material constituting the base layer, it is possible to suitably use a material obtained by incorporating carbon black or the like in an appropriate amount into a resin such as polyimide or polycarbonate or into various rubbers or the like. A thickness of the base layer is, for example, 0.05-0.15 mm. As a material constituting the elastic layer, it is possible to cite natural rubber, styrene-butadiene rubber, butadiene rubber, isoprene rubber, nitrile rubber, chloroprene rubber, butyl rubber, ethylene-propylene rubber, chlorosulfonated rubber, acrylate rubber, epichlorohydrin rubber, methane rubber, silicone rubber, fluorocarbon rubber, and the like. In this embodiment, urethane rubber was used. A thickness of the elastic layer may preferably be 100-2000 μm, more preferably 200-800 μm in order to improve a transfer property of a toner image onto, for example, a recording material S having unevenness by sufficiently utilizing flexibility thereof. As material constituting the surface layer, a resin such as fluorocarbon resin can be suitably used. The surface layer decreases a depositing force of the toner onto the surface of the intermediary transfer belt 70, and thus makes the toner easy to be transferred onto the recording material S in the secondary transfer portion N2. A thickness of the surface layer is, for example, 0.0002-0.020 mm. Further, as a base material of the surface layer, it is possible to use, for example, a resin material of a single kind, such as polyurethane, polyester, or epoxy resin, or materials of two or more kinds selected from elastic materials such as elastomers including elastic rubber, polyurethane, and the like. Further, to this base material, as a material for enhancing a lubricating property by reducing surface energy, it is possible to disperse powder or particles of, for example, fluorocarbon resin such as PTFE, PVDF, or PFA, silicone resin, and the like in a manner such that these materials are dispersed singly or in combination of two or more kinds or in the form of different particle sizes. By this, the surface layer can be formed. In this embodiment, the intermediary transfer belt 70 is 1×10⁸-1×10¹⁴ Ω·cm (23° C., 50% RH) in volume resistivity. Incidentally, the intermediary transfer belt 70 has the three-layer structure in this embodiment, but may also have, for example, a single-layer structure of a material corresponding to the above-described base layer, a two-layer structure consisting of the above-described base layer and the above-described surface layer, or the like layer structure.

On an outer peripheral surface side of the intermediary transfer belt 70, a secondary transfer unit 8 is provided so as to oppose the inner secondary transfer roller 71. The secondary transfer unit 8 includes a secondary transfer belt 80 constituted by an endless belt and an outer secondary transfer roller (secondary transfer roller) 81 provided in a position opposing the inner secondary transfer roller 71 on the inner peripheral surface side of the secondary transfer belt 80. The outer secondary transfer roller 81 which is a roller-type secondary transfer member as a secondary transfer means is pressed toward the inner secondary transfer roller 71 and is contacted to the inner secondary transfer roller 71 through the secondary transfer belt 80 and the intermediary transfer belt 70. By this, the outer secondary transfer roller 81 forms the secondary transfer portion (secondary transfer nip) N2 which is a contact portion between the intermediary transfer belt 70 and the secondary transfer belt 80.

The toner image formed on the intermediary transfer belt 70 is transferred (secondarily transferred) in the secondary transfer portion N2 onto the recording material S nipped and conveyed by the intermediary transfer belt 70 and the secondary transfer belt 80. In this embodiment, during the secondary transfer, to the inner secondary transfer roller 71, a secondary transfer bias (secondary transfer voltage) which is a DC voltage of the same polarity (negative polarity in this embodiment) as the normal charge polarity of the toner is applied by a secondary transfer power source E4 as a secondary transfer voltage applying means (secondary transfer voltage applying portion). Further, in this embodiment, the outer secondary transfer roller 81 is connected to the ground (ground potential) (i.e., is electrically grounded). Details of the secondary transfer unit 8 will be described later.

The recording materials (transfer materials, recording media, sheet) S are accommodated in cassettes 11a and 11b. The recording material S is fed from either one of the cassettes 11a and 11b to a feeding/conveying path 13 as a recording material conveying path by a feeding member 12a or 12b, and then is conveyed toward a registration roller pair 14 as a conveying member. This recording material S is timed to the toner image on the intermediary transfer belt 70 by the registration roller pair 14 and then is conveyed toward the secondary transfer portion N2. Further, in this embodiment, a pre-charging device 9 for electrically charging a surface of the recording material S, onto which the toner image is transferred, before the recording material S reaches the secondary transfer portion N2 is provided upstream of the secondary transfer portion N2 (and downstream of the registration roller pair 14) with respect to a conveying direction of the recording material S. Details of the pre-charging device 9 will be described later.

The recording material S on which the toner image is transferred is conveyed to a fixing device 15 as a fixing means by a conveying belt 19 as a conveying member. The fixing device 15 includes a fixing roller 15a and a pressing belt unit 15b. The fixing roller 15a incorporates a heater as a heating means therein. The recording material S on which an unfixed toner image is carried is heated and pressed by being nipped and conveyed between the fixing roller 15a and the pressing belt unit 15b. By this, the toner image is fixed (fused, stuck) on the recording material S.

In the case of an operation in a one-side printing mode, the recording material S on which the toner image is fixed on one side (surface) thereof as described above passes through a discharge conveying path 16 as a recording material conveying path and then is discharged (outputted) onto a discharge tray 21 as a discharge portion through a post-processing portion 20. In the case of an operation in a double-side printing mode, the recording material S on which the toner image is fixed on one side (surface) as described above is conveyed to the secondary transfer portion N2 again in order to transfer the toner image onto a second side (surface) of the recording material S. That is, in the operation in the double-side printing mode, the recording material S on which the toner image is fixed on the first side thereof is sent toward a reverse conveying path 17 as a recording material conveying path and is subjected to a switch-back operation in the reverse conveying path, so that a leading end and a trailing end of the recording material S are replaced with each other, and then the recording material S is conveyed again to the feeding/conveying path 13. The recording material S conveyed to the feeding/conveying path 13 is conveyed to the registration roller pair 14 and then is conveyed again to the secondary transfer portion N2. Then, on this recording material S, similarly as described above, a toner image is transferred onto a second side (surface) and then is fixed, and thereafter, the recording material S is discharged onto the discharge tray 21.

Further, the toner (primary transfer residual toner) remaining on the photosensitive drum 1 after the primary transfer is removed and collected from the surface of the photosensitive drum 1 by the drum cleaning device 6 as a photosensitive member cleaning means. Further, a deposited matter such as the toner (secondary transfer residual toner) remaining on the intermediary transfer belt 70 after the secondary transfer is removed and collected from the surface of the intermediary transfer belt 70 by a belt cleaning device 74 as an intermediary transfer member cleaning means.

### 2. Control Constitution

FIG. 3 is a blocked diagram showing an outline of a control constitution of the image forming apparatus in this embodiment. The image forming apparatus 100 includes a controller (control circuit) 120 for controlling the image forming apparatus 100. The controller 120 is constituted by including a CPU 121 as arithmetic processing means (arithmetic processing portion), a memory (storing medium) 122 such as a ROM or a RAM as a storing means (storing portion), and an input/output portion (not shown) for performing input/output of information between the controller 120 and an external device. The CPU 121 and the memory 122 are capable of transferring and reading of data therebetween.

In the ROM, a control program, a data table acquired in advance, and the like are stored. In the RAM which is a rewritable memory, information inputted to the controller 120, detected information, a calculation result, and the like are stored.

To the controller 120, the respective portions of the image forming apparatus 100 are connected. The controller 120 controls the respective portions of the image forming apparatus 100 and causes the image forming apparatus 100 to execute various operations such as the image forming operation.

For example, to the controller 120, various power sources such as the charging power source E1, the developing power source E2, the primary transfer power source E3, the secondary transfer power source E4, and the pre-charging power source E5 are connected. Further, to the controller 120, various driving portions such as the drum driving motor D1, the intermediary transfer belt driving motor D2, and a secondary transfer belt driving motor D3 described later are connected.

Further, to the controller 120, an environment sensor 18 is connected. The environment sensor 18 is an example of an environment detecting means for detecting an environment (installation environment of the image forming apparatus 100) which is at least one of a temperature and a humidity inside or outside the image forming apparatus 100. In this embodiment, the environment sensor 18 is constituted by a temperature/humidity sensor for detecting a temperature and a humidity (relative humidity) inside the image forming apparatus 100 (in the neighborhood of the cassettes 11a and 11b). The environment sensor 18 inputs, to the controller 120, signals showing detection results of the temperature and the humidity. On the basis of the temperature and the humidity detected by the environment sensor 18, the controller 120 calculates an absolute water content (absolute humidity) as temperature/humidity information in an environment, and can use the calculated absolute water content in the control.

Further, to the controller 120, an operating portion (operating panel) 130 provided to the image forming apparatus 100 is connected. The operating portion 130 is constituted by including a display portion for displaying various pieces of information to an operator such as a user or a service person by control by the controller 120, and an input portion for inputting, to the controller 120, various settings relating to image formation and the like by the operator. The operating portion 130 may be constituted by a touch panel or the like having functions of the display portion and the input portion. Further, to the controller 102, an image reading apparatus (not shown) and an external device such as a personal computer, which are provided to the image forming apparatus 100 or connected to the image forming apparatus may be connected.

Incidentally, in this embodiment, although illustration is omitted, the charging power source E1, the developing power source E2, and the primary transfer power source E3 are provided independently of each other. Further, the drum driving motor D1 may be provided independently of the photosensitive drum 1, or may be provided in common to all or a part of the photosensitive drums 1. Further, all or a part of the drum driving motor D1, the intermediary transfer belt driving motor D2, and the secondary transfer belt driving motor D3 may be made common.

The image forming apparatus 100 executes a job (print job) which is a series of operations started by a single start instruction and in which the image is formed and outputted on a single recording material S or a plurality of recording materials S. The job includes an image forming step, a pre-rotation step, a sheet (paper) interval step, and a post-rotation step in general. The image forming step is a period in which formation of an electrostatic image for the image actually formed and outputted on the recording material S (exposure), formation of the toner image (development), and transfer of the toner image are carried out, and during image formation refers to this period. Specifically, timings during the image formation are different among positions where the respective steps of the formation of the electrostatic image, the formation of the toner image, and the transfer of the toner image and the fixing are performed. The pre-rotation step is a period in which a preparatory operation, before the image forming step, from an input of the start instruction until the image is started to be actually formed. The sheet interval step is a period corresponding to an interval between a recording material S and a subsequent recording material S when the images are continuously formed on a plurality of recording materials S (continuous image formation). The post-rotation step is a period in which a post-operation (preparatory operation) after the image forming step is performed. During non-image formation is a period other than during image formation and includes the pre-rotation step, the sheet interval step, the post-rotation step and further includes a pre-multi-rotation step which is a preparatory operation during turning-on of a main switch (power source) of the image forming apparatus 100 or during restoration from a sleep state.

### 3. Secondary Transfer Unit

Next, the secondary transfer unit (secondary transfer device) 8 in this embodiment will be described.

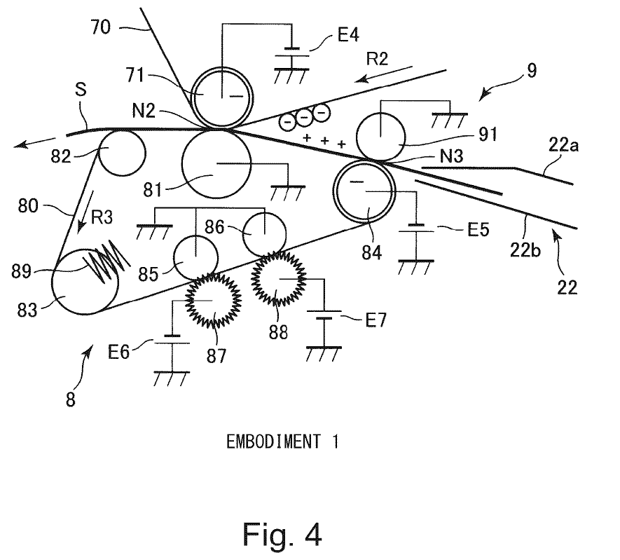

FIG. 4 is a schematic sectional view (showing a cross section substantially perpendicular to a rotational axis direction of the photosensitive drum 1 or rotational axis directions of the stretching rollers for the secondary transfer belt 80) showing the neighborhood of the secondary transfer portion N2 in this embodiment. Incidentally, as regards the secondary transfer belt 80 and the stretching rollers for the secondary transfer belt 80, “upstream” and “downstream” refer to “upstream” and “downstream”, respectively, with respect to a rotational direction (surface movement direction) of the secondary transfer belt 80.

The secondary transfer unit 8 includes the secondary transfer belt 80 constituted by an endless belt as a recording material carrying member. The secondary transfer belt 80 is extended around and stretched at a predetermined tension by a plurality of stretching rollers (supporting rollers). In this embodiment, the secondary transfer unit 8 includes, as the stretching rollers provided on the inner peripheral surface side of the secondary transfer belt 80, an outer secondary transfer roller 81, a separation roller 82, a tension roller 83, and a driving roller (secondary transfer belt driving roller) 84. Further, in this embodiment, the secondary transfer unit 8 includes first and second cleaning opposite rollers 85 and 86 as stretching rollers provided on the inner peripheral surface side of the secondary transfer belt 80. Rotational axis directions of the outer secondary transfer roller 81, the separation roller 82, the tension roller 83, the driving roller 84, and the first and second cleaning opposite rollers 85 and 86 are substantially parallel to each other. Further, these rotational axis directions of the stretching rollers for the secondary transfer belt 80 are substantially parallel to the rotational axis direction of the photosensitive drum 1 and the rotational axis directions of the stretching rollers for the intermediary transfer belt 70.

The secondary transfer belt 80 can be constituted by an endless belt member having a layer formed of a resin material or a metal material. For example, the secondary transfer belt 80 is formed of the resin material adjusted in volume resistivity to 1×10⁹-1×10¹⁴ Ω·cm (23° C., 50% RH) by incorporating carbon black as an antistatic agent in an appropriate amount into a resin such as polyimide, polycarbonate, or the like. The secondary transfer belt 80 may have a single-layer structure or a multi-layer structure. A thickness of the secondary transfer belt 80 is about 0.07-0.1 mm, for example. Further, a peripheral length of the secondary transfer belt 80 is about 300 mm, for example.

The outer secondary transfer roller 81 is disposed opposed to the inner secondary transfer roller 71 through the secondary transfer belt 80 and the intermediary transfer belt 70. The outer secondary transfer roller 81 is pressed toward the inner secondary transfer roller 71 by a pressing mechanism (not shown). The outer secondary transfer roller 81 is contacted to the inner secondary transfer roller 71 through the secondary transfer belt 80 and the intermediary transfer belt 70. By this, the secondary transfer belt 80 and the intermediary transfer belt 70 are sandwiched by the outer secondary transfer roller 81 and the inner secondary transfer roller 71, so that the secondary transfer portion N2 which is a contact portion between the intermediary transfer belt 70 and the secondary transfer belt 80 is formed. In this embodiment, the outer secondary transfer roller 81 includes a core metal and an elastic layer formed with ion-conductive foamed rubber (NBR rubber and ECO rubber) so as to coat an outer periphery of the core metal. An outer diameter of the outer secondary transfer roller 81 is, for example, 15-35 mm. By this, a sufficient nip (secondary transfer portion) N2 can be formed as the secondary transfer portion N2. Further, as the outer secondary transfer roller 81, it is possible to suitably use a roller having an electric resistance value of 1×10⁷-1×10⁸Ω (as measured in N/N (23° C./50% RH) environment under application of a voltage of 2 kV). In the contact portion between the inner secondary transfer roller 71 and the outer secondary transfer roller 81 through the intermediary transfer belt 70 and the secondary transfer belt 80, by a contact force thereof, the elastic layer of the outer secondary transfer roller 81 lower in hardness than the inner secondary transfer roller 71 is elastically deformed.

The separation roller 82 is disposed adjacently to (immediately downstream of) the outer secondary transfer roller 81 on a side downstream of the outer secondary transfer roller 81. By the separation roller 82 and the outer secondary transfer roller 81, a recording material carrying surface (conveying surface) which is an outer peripheral surface of the secondary transfer belt 80 for carrying and conveying the recording material S is formed. The recording material S passed through the secondary transfer portion N2 and electrostatically attracted to the recording material carrying surface of the secondary transfer belt 80 is conveyed by the secondary transfer belt 80, and thereafter, is peeled off from the secondary transfer belt 80 by utilizing curvature. By this, the recording material S is delivered from the secondary transfer belt 80 to the conveying belt 19. In this embodiment, the separation roller 82 is constituted by a metal roller.

The tension roller (secondary transfer belt tension roller) 83 is disposed adjacently to (immediately downstream of) the separation roller 82 on a side downstream of the separation roller 82. The tension roller 83 is pressed from the inner peripheral surface side toward the outer peripheral surface side of the secondary transfer belt 80 by a pressing spring 89 which is an urging member as an urging means, and thus imparts a predetermined tension to the secondary transfer belt 80. In this embodiment, the tension roller 83 is constituted by a metal roller.

The driving roller (secondary transfer belt driving roller) 84 is disposed adjacently to (immediately upstream of) the outer secondary transfer roller 81. By the outer secondary transfer roller 81 and the driving roller 84, a recording material carrying surface (conveying surface) which is an outer peripheral surface of the secondary transfer belt 80 for carrying and conveying the recording material S is formed. In this embodiment, the driving roller 84 includes a core metal, and an elastic layer formed with EPDM rubber (ethylene-propylene(-diene-methylene) rubber) sufficiently low in electric resistance so as to coat an outer periphery of the core metal. By this, electrical conduction between the driving roller 84 and a pre-charging opposite roller 91 described later is established. In this embodiment, an outer diameter of the core metal of the driving roller 84 is 20 mm. Further, in this embodiment, a thickness of the EPDM rubber constituting the elastic layer of the driving roller 84 is 0.5 mm, and a surface thereof is polished and managed so that a surface roughness is substantially constant. The driving roller 84 is rotationally driven by the secondary transfer belt driving motor D3 (FIG. 3) as a driving means. To the secondary transfer belt 80, a driving force is transmitted by the driving roller 84, so that the secondary transfer belt 80 is rotated (circumferential movement) at a predetermined peripheral speed corresponding to the peripheral speed of the intermediary transfer belt 70 in an arrow R3 direction (counterclockwise direction) in FIG. 4. The stretching rollers, for the secondary transfer belt 80, other than the driving roller 84 are rotated with rotation of the secondary transfer belt 80. Incidentally, a roller to which the driving means for conveying the secondary transfer belt 80 is not limited to the driving roller 84 in this embodiment, but may only be required to be either one of rollers contacting the inner peripheral surface of the secondary transfer belt 80. Further, the secondary transfer unit 8 may also be constituted so that the secondary transfer belt 80 is rotated with rotation of the intermediary transfer belt 70.

The first and second cleaning opposite rollers 85 and 86 are disposed on a side downstream of the tension roller 83 and upstream of the driving roller 84, and the first cleaning opposite roller 85 is disposed upstream of the second cleaning opposite roller 86. Further, the secondary transfer unit 8 includes first and second brush rollers 87 and 88 as first and second secondary transfer belt cleaning members in positions opposing the first and second cleaning opposite rollers 85 and 86, respectively on the outer peripheral surface side of the secondary transfer belt 80. To the first brush roller 87, a cleaning bias (cleaning voltage) of the same polarity (negative polarity in this embodiment) as the normal charge polarity is applied from a first cleaning power source E6. Further, to the second brush roller 88, a cleaning bias (cleaning voltage) of an opposite polarity (positive polarity in this embodiment) to the normal charge polarity is applied from a second cleaning power source E7. Each of the first and second cleaning opposite rollers 85 and 86 is electrically grounded. By this, a deposited matter such as toner of the opposite polarity to the normal charge polarity of the toner deposited on the surface of the secondary transfer belt 80, or the like is collected by the first brush roller 87. Further, a deposited matter such as toner of the same polarity as the normal charge polarity of the toner deposited on the surface of the secondary transfer belt 80, or the like is collected by the second brush roller 88. The deposited matters collected by the first and second brush rollers 87 and 88 are removed from the first and second brush rollers 87 and 88 by a collecting member (not shown) or the like, and are accommodated in the collecting member (not shown) or the like. Thus, the surface of the secondary transfer belt 80 can be electrostatically cleaned.

In this embodiment, to the core metal of the inner secondary transfer roller 71, the secondary transfer power source E4 is connected. Further, to the inner secondary transfer roller 71, the secondary transfer bias of the same polarity (negative polarity in this embodiment) as the normal charge polarity of the toner is applied by the secondary transfer power source E4. Further, in this embodiment, the core metal of the outer secondary transfer roller 81 is connected to the ground, so that the outer secondary transfer roller 81 is electrically grounded. Here, such an energizing type that the secondary transfer bias is applied from a side where the toner image is transferred onto the surface of the recording material S is referred to as an “inner energization type”. On the other hand, such an energization type that the secondary transfer bias is applied from a side opposite from the side where the toner image is transferred onto the recording material S is referred to as an “outer energization type”. In the case of the outer energization type, for example, the inner secondary transfer roller 71 is electrically grounded, and to the outer secondary transfer roller 81, the secondary transfer bias of the opposite polarity to the normal charge polarity of the toner is applied.

The inner energization type is improved compared with the outer energization type in a transfer property of the toner image onto a recording material S (low-resistance recording material) low in electric resistance, such as metallic foil paper. This is due to the following reason. In the outer energization type, in the case where the electric resistance of the recording material S is low and leakage of a transfer current to a member or the like in the neighborhood of the secondary transfer portion N2 through the recording material S occurs, the transfer current escapes to the above-described member without contributing to the transfer between the recording material S and the intermediary transfer belt 70. On the other hand, in the inner energization type, even in the case where the electric resistance of the recording material S is low and leakage of the transfer current to the member or the like in the neighborhood of the secondary transfer portion N2 through the recording material S occurs, the transfer current escapes to the above-described member after the transfer current contributes to the transfer between the recording material S and the intermediary transfer belt 70. For that reason, the inner energization type is improved compared with the outer energization type in transfer property of the toner image to the recording material S low in electric resistance.

In this embodiment, the secondary transfer bias is applied by constant-voltage control. A voltage value (target voltage) of the secondary transfer bias is determined to a voltage value which is the sum of a base voltage Vb for obtaining a predetermined transfer current and a recording material part voltage Vp determined depending on a kind of the recording material S. The recording material part voltage Vp is set in advance depending on the kind of the recording material S and in addition, depending on an environment (for example, an absolute water content), and then is stored as table data or the like in the memory 122. The base voltage Vb can be obtained, for example, on the basis of a detection result of a current or a voltage when a single or a plurality of values of test biases (test currents or test voltages) are applied to the secondary transfer portion N2 in a state in which the toner image and the recording material S are absent in the secondary transfer portion N2. For example, constant-current control in which a predetermined current is used as the target current is carried out, and on the basis of a voltage generated at that time, the base voltage Vb can be acquired. The predetermined transfer current is set in advance depending on, for example, the environment (such as the absolute water content) and is stored as table data in the memory 122. Such control is called secondary transfer voltage determination control or ATVC (Active Transfer Voltage Control). By this, the secondary transfer bias can be changed depending on the electric resistance of the secondary transfer portion N2 which is sequentially changed by a change in environment or a use status (cumulative use amount) of a member relating to the secondary transfer. The member relating to the secondary transfer is the inner secondary transfer roller 71, the outer secondary transfer roller 81, the intermediary transfer belt 70, the secondary transfer belt 80, or the like. Here, the constant-current control is control in which an output of a power source is adjusted so that a current supplied to a supply object becomes substantially constant at the target current. Further, the constant-voltage control is control in which the output of the power source is adjusted so that a voltage applied to an application object becomes substantially constant at the target voltage. Further, the kind of the recording material S includes arbitrary information capable of discriminating the recording material S, inclusive of attributes (so-called paper kind category) based on general features such as plain paper, coated paper, thick paper, an synthetic paper; numerical values and numerical value ranges such as a basis weight and a thickness; brands (including manufactures, product numbers, and the like); and so on. In general, the kind of the recording material S is identified by the paper kind category and the thickness (or the basis weight) in many cases.

### 4. Pre-Charging Device

Next, the pre-charging device (recording material charging device) 8 in this embodiment will be further described.

As described above, in the image forming apparatus, depending on the specifications of the recording material, there is a possibility that an image defect such as a transfer void due to shortage of the transfer current. Recently, for example, in a production machine of an intermediary transfer type, there is a tendency that the kind of the recording material used in the image formation increases. For example, in the production machine high in image forming speed, there are cases where it is difficult to properly secondarily transfer the toner image onto a recording material (high-resistance recording material), without lowering productivity, such as ultra-thick paper (high-resistance paper) or synthetic paper high in electric resistance due to that the synthetic paper includes a resin layer. For example, in a low-humidity environment, the electric resistance of the outer secondary transfer roller becomes high, and therefore, there is a need that an absolute value of a voltage of the secondary transfer bias for passing a necessary transfer current is made large. There are cases where the absolute value of the voltage of the secondary transfer bias is required to be made 10 kV or more. In such cases where the secondary transfer bias exceeds a high-voltage capacitance, there is a possibility that the transfer void due to the shortage of the transfer current occurs. This transfer void occurs, for example, in a secondary-color toner image. Further, a high-voltage power source capable of applying such a secondary transfer bias is expensive, so that there is a possibility that the high-voltage source becomes a factor of an increase in cost of the image forming apparatus. Further, even when such a high-voltage source is intended to be used, due to convenience of arrangement, a creepage surface cannot be ensured in some cases, so that the secondary transfer bias large in absolute value of the voltage as described above cannot be applied in some cases. Further, when the absolute value of the voltage of the secondary transfer bias is made large, an image defect due to an electric discharge phenomenon in the secondary transfer portion occurs, so that it is difficult to obtain an appropriate image in some cases. As the image defect due to the discharge phenomenon, a stripe-shaped image defect and an image defect called a white void or penetration, which are caused due to that a part of the toner image is not transferred or that a part of the toner image is disturbed (scattered) occur in some instances.

Therefore, in this embodiment, the image forming apparatus 100 is constituted so that a surface of the recording material S onto which the toner image is transferred (toner image transfer surface) is capable of being charged in advance to an opposite polarity to the normal charge polarity of the toner. By this, even when the absolute value of the voltage of the secondary transfer bias is made relatively small, it becomes possible to appropriately transfer the toner image onto the recording material S.

As shown in FIG. 4, in this embodiment, the pre-charging device 9 for charging the toner image transfer surface of the recording material S to the opposite polarity to the normal charge polarity before the recording material S reaches the secondary transfer portion N2 is provided upstream of the secondary transfer portion N2 (downstream of the registration roller pair 14) with respect to the conveying direction of the recording material S. By this, a transfer property of the toner image onto the ultra-thick paper or the synthetic paper can be improved.

In this embodiment, the pre-charging roller 9 is constituted by including the driving roller (secondary transfer belt driving roller) 84 disposed on the inner peripheral surface side of the secondary transfer belt 80 and the pre-charging opposite roller 91 disposed opposed to the driving roller 84 through the secondary transfer belt 80. The driving roller (recording material charging roller) 84 in this embodiment is an example of a recording material charging member (pre-charging member). The driving roller 84 is a stretching roller for the secondary transfer belt 80 and has a function of a driving roller for driving the secondary transfer belt 80 and a function of the recording material charging member in combination. Further, the pre-charging roller 91 in this embodiment is an example of an opposite member (pre-charging opposite member).

The pre-charging roller 91 forms a desired nip state with the driving roller 84 and nips the recording material S therebetween. That is, the driving roller 84 contacts the pre-charging opposite roller 91 through the secondary transfer belt 80. By this, the secondary transfer belt 80 is nipped by the driving roller 84 and the pre-charging opposite roller 91, so that a pre-charging portion (pre-charging nip, recording material charging portion) N3 which is a contact portion between the secondary transfer belt 80 and the pre-charging opposite roller 91 is formed. Incidentally, a length of a portion, where these rollers are contactable to the recording material S, in a rotational axis direction of the pre-charging opposite roller 91 is longer than a length, in the same direction, of the recording material S usable in the image forming apparatus 100 (i.e., the recording material S falls within a range of the lengths of the respective rollers in the rotational axis direction).

In this embodiment, the pre-charging opposite roller 91 is an elastic sponge roller including a core metal, and an elastic foamed member layer formed with the ion-conductive foamed rubber (NBR rubber, ECO rubber) sufficiently low in electric resistance so as to coat an outer periphery of the core metal. In this embodiment, an outer diameter of the pre-charging opposite roller 91 is 15 mm. The outer diameter of the pre-charging opposite roller 91 is, for example, about 5-30 mm, preferably 10-20 mm. Thus, the pre-charging opposite roller 91 is constituted by a relatively small-diameter roller, whereby a distance between the surface of the pre-charging opposite roller 91 and the surface of the intermediary transfer belt 70 can be sufficiently ensured. A distance from the pre-charging portion N3 to the secondary transfer portion N2 in the conveying direction of the recording material S is, for example, about 10-100 mm, preferably 30 mm or less. By this, in the case where the toner image transfer surface of the recording material S is charged in the pre-charging portion N3, it is possible to suppress attenuation of a charge amount of the toner image transfer surface of the recording material S in a period until the recording material S is conveyed to the secondary transfer portion N2.

In this embodiment, to the core metal of the driving roller 84, the pre-charging power source E5 as a pre-charging voltage applying means (pre-charging voltage applying portion) is connected. Further, to the driving roller 84, a pre-charging bias (recording material charging bias, pre-charging voltage) of the same polarity (negative polarity in this embodiment) as the normal charge polarity of the toner is applied by the pre-charging power source E5. Further, in this embodiment, the core metal of the pre-charging opposite roller 91 is connected to the ground, so that the pre-charging opposite roller 91 is electrically grounded. Thus, in this embodiment, to the driving roller 84, the pre-charging bias of the same polarity as the polarity of the secondary transfer bias applied to the inner secondary transfer roller 71 is applied. That is, to the inner secondary transfer roller 71 and the driving roller 84, the biases the same polarity are applied to the recording material S from different surface sides of the recording material S. The pre-charging bias of the same polarity as the normal charge polarity of the toner is applied to the surface of the recording material S opposite from the toner image transfer surface of the recording material S, so that the surface of the recording material S opposite from the toner image transfer surface of the recording material S is charged to the same polarity (negative polarity in this embodiment) as the normal charge polarity of the toner. By this, the toner image transfer surface of the recording material S is charged to the opposite polarity (positive polarity in this embodiment) to the normal charge polarity of the toner by electric charges induced from the ground. At this time, a current apparently flows through the pre-charging portion N3.

In this embodiment, the pre-charging bias is applied by the constant-current control. The pre-charging power source E5 incorporates a current detecting portion (not shown) as a current detecting means, and is capable of carrying out the constant-current control of an outer voltage so that a value of a current detected by this current detecting portion becomes substantially constant.

Here, the target current of an appropriate pre-charging bias varies depending on the kind, the environment, and further a print surface (surface onto which the toner is transferred in the secondary transfer portion N2 immediately after the recording material S passes through the pre-charging portion N3 or whether or not a first surface of the one-side printing or the double-side printing or a second surface of the double-side printing) of the recording material S.

For that reason, on the basis of at least one of the kind, the environment, and the print surface of the recording material S, whether or not the pre-charging bias is applied can be determined or the target current of the pre-charging bias can be changed. For example, the target current of the pre-charging bias may be set in advance and then is stored as table data in the memory 122 depending on the kind or the environment (for example, an absolute water content) of the recording material S so that the toner image transfer surface of the recording material S has an appropriate charge amount. The appropriate charge amount of the toner image transfer surface of the recording material S can be acquired in advance as an appropriate charge amount, in which an appropriate transfer property can be obtained, by an experiment or the like. Further, for example, only in the case where the recording material S of a predetermined kind is used or only in the case where the recording material S of the predetermined kind is used, and in addition, the absolute water content falls within a predetermined range (for example, the absolute water content is smaller than a predetermined value), the pre-charging bias may be applied or the like.

The recording material S conveyed by the registration roller pair 14 is conveyed to the normal (pre-charging portion) N3 between the pre-charging opposite roller 91 and the secondary transfer belt 80 extended around the driving roller 84. Incidentally, in this embodiment, with respect to the conveying direction of the recording material S, a guiding member 22 (upper guiding member 22a, lower guiding member 22b) for guiding the recording material S is provided upstream of the pre-charging portion N3 and downstream of the registration roller pair 14. The recording material S conveyed by the registration roller pair 14 is conveyed toward the pre-charging portion N3 while being guided by the guiding member 22.

Then, in the pre-charging portion N3, the recording material S is charged (pre-charged), and in addition, the recording material S is electrostatically attracted to the secondary transfer belt 80 (by an electrostatic force). The recording material S attracted to the secondary transfer belt 80 is conveyed to the secondary transfer portion N2, where the toner image is transferred (secondarily transferred) onto the recording material S.

### 5. Evaluation

As an example, in an environment of a temperature of 23° C. and a humidity of 60% RH, a transfer property of a toner image onto synthetic paper (“YUPO YPI200”, product name of YUPO Corp.) as the recording material S. Evaluation was performed for this embodiment, a comparison example 1-1, and a comparison example 1-2. An evaluation result is shown in a table 1 appearing hereinafter. Incidentally, in the table 1, “◯” represents good, and “x” represents poor.

### Comparison Example 1-1

As the comparison example 1-1, the transfer property of the toner image in the case where the pre-charging is not performed (in the case where a voltage value of the pre-charging bias is 0 V) in the constitution of this embodiment was evaluated.

In the comparison example 1-1, even when a secondary transfer bias of a voltage value (about −8.0 kV) obtained by adding a maximum recording material part voltage Vp to a base voltage Vb (base voltage for a normal processing speed) was applied, a transfer current of −70 μA which is an appropriate transfer current was not able to be passed. Further, improver transfer (transfer void) occurred in a secondary-color toner image of magenta and cyan in some instances. Further, in the comparison example 1-1, an absolute value of the voltage of the secondary transfer belt was large, and therefore, an image defect (stripe) due to the discharge phenomenon in the secondary transfer portion N2 occurred in some instances.

### Comparison Example 1-2

As the comparison example 1-2, the toner image transfer property in the case where the pre-charging was performed in the following constitution was evaluated. The constitution of the comparison example 1-2 was substantially same as the constitution of this embodiment except that the following point is different. Further, also as regards the constitution of the comparison example 1-2, elements having identical or corresponding functions or constitutions to those in this embodiment (embodiment 1) will be described by adding thereto the same reference numerals or symbols.

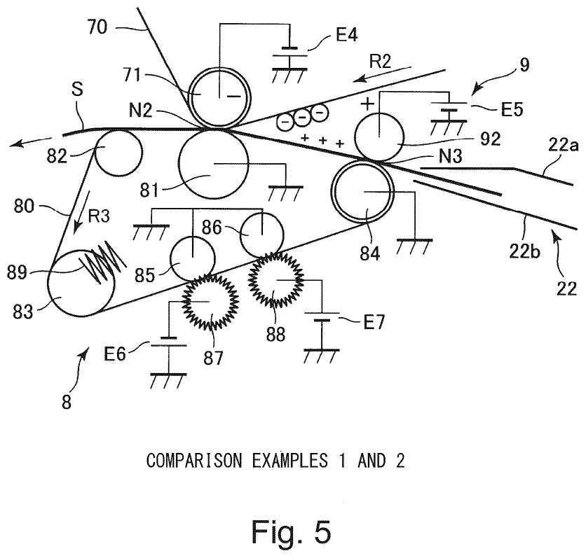

FIG. 5 is a schematic sectional view (showing across section substantially perpendicular to the rotational axis direction of the photosensitive drum 1 or the rotational axis directions of the stretching rollers for the secondary transfer belt 80) showing the neighborhood of the secondary transfer belt N2 in the comparison example 1-2. In the comparison example 1-2, similarly as in this embodiment, to the inner secondary transfer roller 71, a secondary transfer bias of the same polarity (negative polarity) as the normal charge polarity of the toner by the secondary transfer power source E4. Further, in the comparison example 1-2, to the pre-charging roller 92 corresponding to the pre-charging opposite roller 91 in this embodiment, a pre-charging bias of the opposite polarity (positive polarity) to the normal charge polarity of the toner by the pre-charging power source E5. Further, in the comparison example 1-2, the driving roller (secondary transfer belt driving roller) 84 is electrically grounded. Incidentally, a constitution of the pre-charging roller 92 in the comparison example 1-2 is substantially the same as a constitution of the pre-charging opposite roller 91 in this embodiment.

In the comparison example 1-2, a voltage value of the secondary transfer bias necessary to cause a transfer current of −70 μA which is an appropriate transfer current to flow was about −6.0 kV. Further, in the comparison example 1-2, a current of +30 μA is intended to be supplied to the pre-charging roller 92, but each of a negative secondary transfer bias of −6.0 kV and a positive pre-charging bias of +5.5 kV is large in absolute value, and therefore, the following result was obtained. That is, a negative (−) current by the secondary transfer bias and a positive (+) current by the pre-charging bias which flow through an inside of the recording material S or the surface of the recording material S cancel each other, and thus a necessary transfer current cannot be obtained, so that improper transfer (transfer void) occurred in a secondary-color solid image of magenta and cyan in some instances. Incidentally, in the comparison example 1-2, the image defect (stripe) due to the discharge phenomenon in the secondary transfer portion N2 did not occur.

### This Embodiment (Embodiment 1)

In this embodiment, in the pre-charging device 9, a current of −30 μA was supplied to the driving roller 84 by applying the pre-charging bias to the driving roller 84. In this case, the voltage value of the pre-charging bias applied to the driving roller 84 was −5.5 kV, and the toner image transfer surface of the synthetic paper (YUPO YPI200) immediately after passing through the pre-charging portion N3 was charged to about +3.0 kV. Further, the voltage value of the secondary transfer bias necessary to cause the transfer current of −70 μA which is the appropriate transfer current to flow was about −6.0 kV. Further, in this embodiment, the improper transfer (transfer void) of the secondary-color solid image of magenta and cyan did not occur. In addition, in this embodiment, the image defect (stripe) due to the discharge phenomenon in the secondary transfer portion N2 did not occur.

### 6. Effect

As described above, the image forming apparatus 100 includes the image bearing member (photosensitive drum 1) for bearing the toner image, the intermediary transfer belt 70 onto which the toner image is transferred from the image bearing member 1, the plurality of stretching rollers for stretching the intermediary transfer belt 7 and including the inner roller (inner secondary transfer roller) 71 for forming the secondary transfer portion N2 when the toner image is transferred from the intermediary transfer belt 70 onto the recording material S, the secondary transfer member (outer secondary transfer roller) 81 provided on the outer peripheral surface side of the intermediary transfer belt 70 and for forming the secondary transfer portion N2 in cooperation with the inner roller 71, a first applying portion (secondary transfer power source) E4 for applying, to the inner roller 71, the secondary transfer bias of the same polarity as the normal charge polarity of the toner in order to transfer the toner image from the intermediary transfer belt 70 onto the recording material S, the recording material charging member (secondary transfer belt driving roller) 84 provided upstream of the secondary transfer portion N2 with respect to the conveying direction of the recording material S on the surface side thereof opposite from the side where the toner image is to be transferred onto the recording material S conveyed to the secondary transfer portion N2 and for forming the recording material charging portion (pre-charging portion) N3 where the recording material S is charged, an opposite member (pre-charging opposite roller) 91 provided opposed to the recording material charging member 84 and for forming the recording material charging portion N3 in cooperation with the recording material charging member 84, and a second applying portion (pre-charging power source) E5 for applying, to the recording material charging member 84, the recording material charging bias of the same polarity as the polarity of the secondary transfer bias in order to charge the toner image transfer surface of the recording material S to the opposite polarity to the normal charge polarity of the toner. In this embodiment, the image forming apparatus 100 includes the secondary transfer belt 80 stretched by the plurality of rollers including the secondary transfer roller (outer secondary transfer roller) 81 which is the secondary transfer member and the recording material charging roller (driving roller) 84 which is the recording material charging member, wherein the secondary transfer roller 81 forms the secondary transfer portion N2 in contact with the inner roller 71 through the secondary transfer belt 80 and the intermediary transfer belt 70, and the recording material charging roller 84 forms the recording material charging portion N3 in contact with the opposite member 91 through the secondary transfer belt 80. Further, in this embodiment, the opposite member 91 is an opposite roller (pre-charging opposite roller) contacting the recording material charging roller 84 through the secondary transfer belt 80. Further, in this embodiment, the recording material charging bias is subjected to the constant-current control. In addition, in this embodiment, the secondary transfer bias is subjected to the constant-voltage control.

Further, according to this embodiment, without lowering productivity, the transfer property of the toner image onto the ultra-thick paper or the synthetic paper which are high in electric resistance. Thus, according to this embodiment, the recording material S can be effectively charged in the pre-charging portion N3 by suppressing that the current flows through between the secondary transfer portion N2 and the pre-charging portion N3.

### Embodiment 2

Next, another embodiment of the present invention will be described. Basic constitutions and operations of an image forming apparatus in this embodiment are the same as those of the image forming apparatus of the embodiment 1. Accordingly, in the image forming apparatus of this embodiment, elements having the same or corresponding functions or constitutions as those of the image forming apparatus of the embodiment 1 are represented by the same reference numerals or symbols as those in the embodiment 1 and will be omitted from detailed description.

### 1. Constituent of this Embodiment

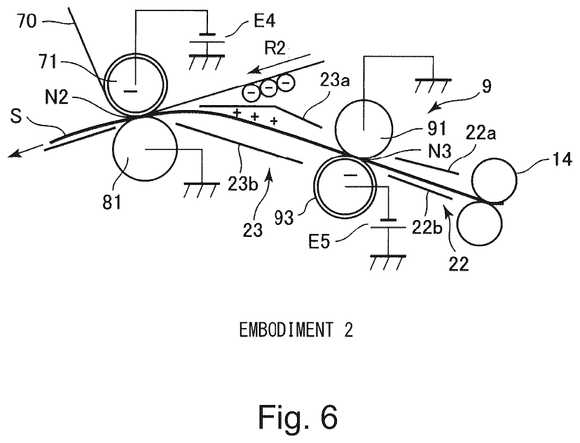

FIG. 6 is a schematic sectional view (showing a cross section substantially perpendicular to the rotational axis direction of the photosensitive drum 1 or the rotational axis directions of the stretching rollers for the intermediary transfer belt 70) showing the neighborhood of a secondary transfer portion N2 in this embodiment.

In this embodiment, the image forming apparatus 100 includes the outer secondary transfer roller 81 directly contacted to the outer peripheral surface of the intermediary transfer belt 70. The outer secondary transfer roller 81 is pressed toward the inner secondary transfer roller 71 and is contacted to the inner secondary transfer roller 71 through the intermediary transfer belt 70, so that the outer secondary transfer roller 81 forms the secondary transfer portion N2 which is the contact portion between the intermediary transfer belt 70 and the outer secondary transfer roller 81. A constitution of the outer secondary transfer roller 81 in this embodiment is substantially the same as the constitution of the outer secondary transfer roller 81 in the embodiment 1.

In this embodiment, similarly as in the embodiment 1, the secondary transfer power source D4 is connected to the core metal of the inner secondary transfer roller 71, and to the inner secondary transfer roller 71, the secondary transfer bias of the same polarity (negative polarity in this embodiment) as the normal charge polarity of the toner is applied by the secondary transfer power source E4. Further, in this embodiment, the core metal of the outer secondary transfer roller 81 is connected to the ground, and thus the outer secondary transfer roller 81 is electrically grounded.

Further, in this embodiment, the pre-charging device 9 includes a pre-charging roller 93 contacting a surface of the recording material S on a side opposite from a toner image transfer surface of the recording material S, and a pre-charging opposite roller 91 contacting the toner image transfer surface of the recording material S. The pre-charging roller 93 in this embodiment is an example of the recording material charging member (pre-charging member). Further, the pre-charging opposite roller 91 in this embodiment is an example of the opposite member (pre-charging opposite member). By the pre-charging roller 93 and the pre-charging opposite roller 91, a pre-charging portion (pre-charging nip) N3 which is a contact portion between these rollers is formed. Incidentally, a constitution of the pre-charging roller 93 in this embodiment is substantially the same as the constitution of the driving roller (secondary transfer belt driving roller) 84 in the embodiment 1. Further, a constitution of the pre-charging opposite roller 91 in this embodiment is substantially the same as the constitution of the pre-charging opposite roller 91 in the embodiment 1. Incidentally, in this embodiment, each of the pre-charging roller 93 and the pre-charging opposite roller 91 is not driven by the driving means and is driven with movement of the recording material S conveyed by the registration roller pair 14. However, at least one of the pre-charging roller 93 and the pre-charging opposite roller 91 may be rotationally driven by the driving means.

Further, in this embodiment, to the core metal of the pre-charging roller 93, the pre-charging power source E5 is connected, and to the pre-charging roller 93, a pre-charging bias of the same polarity (negative polarity in this embodiment) as the normal charge polarity of the toner is applied by the pre-charging power source E5. Further, in this embodiment, the core metal of the pre-charging opposite roller 91 is connected to the ground, so that the pre-charging opposite roller 91 is electrically grounded. Thus, in this embodiment, to the pre-charging roller 93, the pre-charging bias of the same polarity as the polarity of the secondary transfer bias applied to the inner secondary transfer roller 71 is applied. That is, to the inner secondary transfer roller 71 and the pre-charging roller 93, the biases the same polarity are applied to the recording material S from different surface sides of the recording material S.

The recording material S conveyed by the registration roller pair 14 is charged in the pre-charging portion N3 so that the toner image transfer surface of the recording material S is charged to the opposite polarity (positive polarity in this embodiment) to the normal charge polarity of the toner by the pre-charging bias of the negative polarity applied to the pre-charging roller 93. The recording material S passed through the pre-charging portion N3 is conveyed to the secondary transfer portion N2, where the toner image is transferred (secondarily transferred) onto the recording material S.

Incidentally, in this embodiment, with respect to the conveying direction of the recording material S, a first guiding member 22 (upper guiding member 22a, lower guiding member 22b) for guiding the recording material S is provided upstream of the pre-charging portion N3 and downstream of the registration roller pair 14. The recording material S conveyed by the registration roller pair 14 is conveyed toward the pre-charging portion N3 while being guided by the guiding member 22. Further, in this embodiment, with respect to the conveying direction of the recording material S, on a side upstream of the secondary transfer portion N2 and downstream of the pre-charging portion N3, a second guiding member 23 (upper guiding member 23a, lowering guiding member 23b) for guiding the recording material S is provided. The recording material S passed through the pre-charging portion N3 is conveyed toward the secondary transfer portion N2 while being guided by the second guiding member 23.

### 2. Evaluation

As an example, in an environment of a temperature of 23° C. and a humidity of 60% RH, a transfer property of a toner image onto synthetic paper as the recording material S. Evaluation was performed for this embodiment, and a comparison example. An evaluation result is shown in the table 1 appearing hereinafter.

### This Embodiment (Embodiment 2)

In this embodiment, in the pre-charging device 9, a current of −30 μA was supplied to the driving roller 84 by applying the pre-charging bias to the driving roller 84. In this case, the voltage value of the pre-charging bias applied to the driving roller 84 was −5.5 kV, and the toner image transfer surface of the synthetic paper (YUPO YPI200) immediately after passing through the pre-charging portion N3 was charged to about +3.0 kV. Further, the voltage value of the secondary transfer bias necessary to cause the transfer current of −70 μA which is the appropriate transfer current to flow was about −5.0 kV. Further, in this embodiment, the improper transfer (transfer void) of the secondary-color solid image of magenta and cyan did not occur. In addition, in this embodiment, the image defect (stripe) due to the discharge phenomenon in the secondary transfer portion N2 did not occur.

### Comparison Example 2

As the comparison example 2, the toner image transfer property in the case where the pre-charging was performed in the following constitution was evaluated. The constitution of the comparison example 2 was substantially same as the constitution of this embodiment except that the following point is different. Further, also as regards the constitution of the comparison example 2, elements having identical or corresponding functions or constitutions to those in this embodiment (embodiment 1) will be described by adding thereto the same reference numerals or symbols.

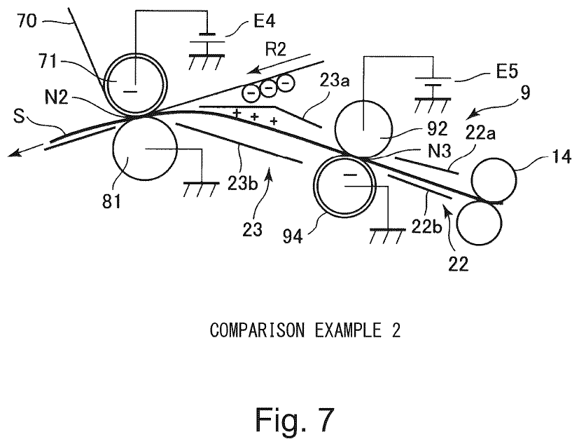

FIG. 7 is a schematic sectional view (showing across section substantially perpendicular to the rotational axis direction of the photosensitive drum 1 or the rotational axis directions of the stretching rollers for the intermediary transfer belt 70) showing the neighborhood of the secondary transfer belt N2 in the comparison example 2. In the comparison example 2, similarly as in this embodiment, to the inner secondary transfer roller 71, a secondary transfer bias of the same polarity (negative polarity in this comparison example 2) as the normal charge polarity of the toner by the secondary transfer power source E4. Further, in the comparison example 2, to the pre-charging roller 92 corresponding to the pre-charging opposite roller 91 in this embodiment, a pre-charging bias of the opposite polarity (positive polarity in this comparison example 2) to the normal charge polarity of the toner. Further, in the comparison example 2, the pre-charging opposite roller 94 corresponding to the pre-charging roller 93 in this embodiment is electrically grounded. Incidentally, a constitution of the pre-charging roller 92 in the comparison example 2 is substantially the same as a constitution of the pre-charging opposite roller 91 in this embodiment. Further, a constitution of the pre-charging roller 94 in the comparison example 2 is substantially the same as a constitution of the pre-charging roller 93 in this embodiment.

In the comparison example 2, a voltage value of the secondary transfer bias necessary to cause a transfer current of −70 μA which is an appropriate transfer current to flow was about −5.0 kV. Further, in the comparison example 2, a current of +30 μA is intended to be supplied to the pre-charging roller 92, but each of a negative secondary transfer bias of −5.0 kV and a positive pre-charging bias of +5.0 kV is large in absolute value, and therefore, the following result was obtained. That is, a negative (−) current by the secondary transfer bias and a positive (+) current by the pre-charging bias which flow through an inside of the recording material S or the surface of the recording material S cancel each other, and thus a necessary transfer current cannot be obtained, so that improper transfer (transfer void) occurred in a secondary-color solid image of magenta and cyan in some instances. Incidentally, in the comparison example 2, the image defect (stripe) due to the discharge phenomenon in the secondary transfer portion N2 did not occur.

### 3. Effect

As described above, in this embodiment, the recording material charging member is the recording material charging roller (pre-charging roller) 93, and the opposite member is the opposite roller (pre-charging opposite roller 91 contacting the recording material charging roller 93. Further, in this embodiment, the secondary transfer member forms the secondary transfer portion N2 in contact with the inner roller 71 through the intermediary transfer belt 70.

Further, according to this embodiment, similarly as in the embodiment 1, the recording material S can be effectively charged in the pre-charging portion N3 by suppressing that the current flows through between the secondary transfer portion N2 and the pre-charging portion N3.

### Embodiment 3

Next, another embodiment of the present invention will be described. Basic constitutions and operations of an image forming apparatus in this embodiment are the same as those of the image forming apparatus of the embodiment 1. Accordingly, in the image forming apparatus of this embodiment, elements having the same or corresponding functions or constitutions as those of the image forming apparatus of the embodiment 1 are represented by the same reference numerals or symbols as those in the embodiment 1 and will be omitted from detailed description.

### 1. Constituent of this Embodiment

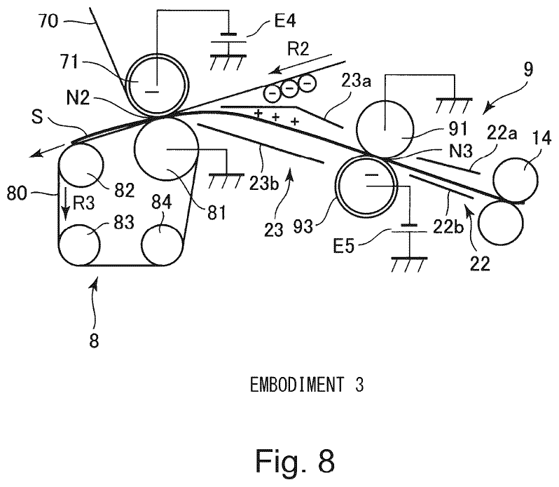

FIG. 8 is a schematic sectional view (showing a cross section substantially perpendicular to the rotational axis direction of the photosensitive drum 1 or the rotational axis directions of the stretching rollers for the intermediary transfer belt 70) showing the neighborhood of a secondary transfer portion N2 in this embodiment.

In this embodiment, the image forming apparatus 100 includes a secondary transfer unit 8 provided with a secondary transfer belt 80. The secondary transfer unit 8 is constituted by including, as a plurality of stretching rollers, the outer secondary transfer roller 81, the separation roller 82, the tension roller 83, and the driving roller 84. However, in this embodiment, with respect to the conveying direction of the recording material S, on a side upstream of the secondary transfer portion N2, a surface on which the roller S is carried is not formed. The recording material S directly enters the secondary transfer portion N2 without being carried on the secondary transfer belt 80.

In this embodiment, similarly as in the embodiment 1, the secondary transfer power source D4 is connected to the core metal of the inner secondary transfer roller 71, and to the inner secondary transfer roller 71, the secondary transfer bias of the same polarity (negative polarity in this embodiment) as the normal charge polarity of the toner is applied by the secondary transfer power source E4. Further, in this embodiment, the core metal of the outer secondary transfer roller 81 is connected to the ground, and thus the outer secondary transfer roller 81 is electrically grounded.

Further, in this embodiment, the pre-charging device 9 includes, similarly as in the embodiment 2, a pre-charging roller 93 contacting a surface of the recording material S on a side opposite from a toner image transfer surface of the recording material S, and a pre-charging opposite roller 91 contacting the toner image transfer surface of the recording material S. Further, in this embodiment, similarly as in the embodiment 2, to the core metal of the pre-charging roller 93, the pre-charging power source E5 is connected, and to the pre-charging roller 93, a pre-charging bias of the same polarity (negative polarity in this embodiment) as the normal charge polarity of the toner is applied by the pre-charging power source E5. Further, in this embodiment, the core metal of the pre-charging opposite roller 91 is connected to the ground, so that the pre-charging opposite roller 91 is electrically grounded.

The recording material S conveyed by the registration roller pair 14 is charged in the pre-charging portion N3 so that the toner image transfer surface of the recording material S is charged to the opposite polarity (positive polarity in this embodiment) to the normal charge polarity of the toner by the pre-charging bias of the negative polarity applied to the pre-charging roller 93. The recording material S passed through the pre-charging portion N3 is conveyed to the secondary transfer portion N2, where the toner image is transferred (secondarily transferred) onto the recording material S. Incidentally, in this embodiment, similarly as in the embodiment 2, in the conveying path of the recording material S, a first guiding member 22 (upper guiding member 22a, lower guiding member 22b) and a second guiding member 23 (upper guiding member 23a, lower guiding member 23b) and provided.

### 2. Evaluation

As an example, in an environment of a temperature of 23° C. and a humidity of 60% RH, a transfer property of a toner image onto synthetic paper as the recording material S. Evaluation was performed for this embodiment, and a comparison example 3. An evaluation result is shown in the table 1 appearing hereinafter.

### This Embodiment (Embodiment 3)

In this embodiment, in the pre-charging device 9, a current of −30 μA was supplied to the driving roller 84 by applying the pre-charging bias to the driving roller 84. In this case, the voltage value of the pre-charging bias applied to the driving roller 84 was −5.5 kV, and the toner image transfer surface of the synthetic paper (YUPO YPI200) immediately after passing through the pre-charging portion N3 was charged to about +3.0 kV. Further, the voltage value of the secondary transfer bias necessary to cause the transfer current of −70 uA which is the appropriate transfer current to flow was about −6.0 kV. Further, in this embodiment, the improper transfer (transfer void) of the secondary-color solid image of magenta and cyan did not occur. In addition, in this embodiment, the image defect (stripe) due to the discharge phenomenon in the secondary transfer portion N2 did not occur.

### Comparison Example 3

As the comparison example 3, the toner image transfer property in the case where the pre-charging was performed in the following constitution was evaluated. The constitution of the comparison example 3 was substantially same as the constitution of this embodiment except that the following point is different. Further, also as regards the constitution of the comparison example 3, elements having identical or corresponding functions or constitutions to those in this embodiment (embodiment 1) will be described by adding thereto the same reference numerals or symbols.

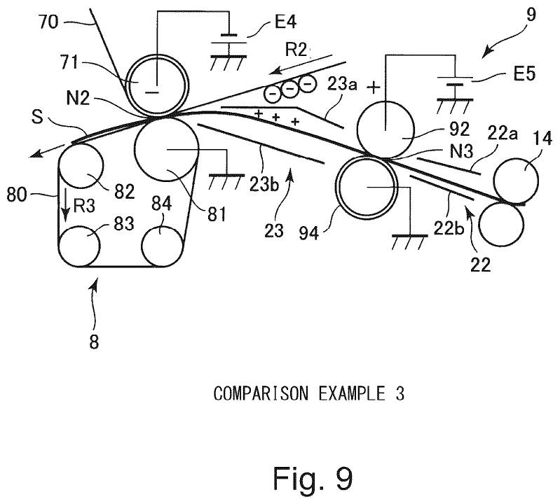

FIG. 9 is a schematic sectional view (showing across section substantially perpendicular to the rotational axis direction of the photosensitive drum 1 or the rotational axis directions of the stretching rollers for the intermediary transfer belt 70) showing the neighborhood of the secondary transfer belt N2 in the comparison example 3. In the comparison example 3, similarly as in this embodiment, to the inner secondary transfer roller 71, a secondary transfer bias of the same polarity (negative polarity) as the normal charge polarity of the toner by the secondary transfer power source E4. Further, in the comparison example 3, to the pre-charging roller 92 corresponding to the pre-charging opposite roller 91 in this embodiment, a pre-charging bias of the opposite polarity (positive polarity) to the normal charge polarity of the toner. Further, in the comparison example 3, the pre-charging opposite roller 94 corresponding to the pre-charging roller 93 in this embodiment is electrically grounded. Incidentally, a constitution of the pre-charging roller 92 in the comparison example 3 is substantially the same as a constitution of the pre-charging opposite roller 91 in this embodiment. Further, a constitution of the pre-charging roller 94 in the comparison example 3 is substantially the same as a constitution of the pre-charging roller 93 in this embodiment.

In the comparison example 2, a voltage value of the secondary transfer bias necessary to cause a transfer current of −70 μA which is an appropriate transfer current to flow was about −6.0 kV. Further, in the comparison example 3, a current of +30 μA is intended to be supplied to the pre-charging roller 92, but each of a negative secondary transfer bias of −6.0 kV and a positive pre-charging bias of +5.5 kV is large in absolute value, and therefore, the following result was obtained. That is, a negative (−) current by the secondary transfer bias and a positive (+) current by the pre-charging bias which flow through an inside of the recording material S or the surface of the recording material S cancel each other, and thus a necessary transfer current cannot be obtained, so that improper transfer (transfer void) occurred in a secondary-color solid image of magenta and cyan in some instances. Incidentally, in the comparison example 3, the image defect (stripe) due to the discharge phenomenon in the secondary transfer portion N2 did not occur.

### 3. Effect

As described above, in this embodiment, the recording material charging member is the recording material charging roller (pre-charging roller) 93, and the opposite member is the opposite roller (pre-charging opposite roller 91 contacting the recording material charging roller 93. Further, in this embodiment, the image forming apparatus 100 includes the secondary transfer belt 80 stretched by the plurality of rollers including the secondary transfer roller (outer secondary transfer roller) 81 which is the secondary transfer member, and the secondary transfer roller 81 forms the secondary transfer portion N2 in contact with the inner roller 71 through the secondary transfer belt 80 and the intermediary transfer belt 70.

Further, according to this embodiment, similarly as in the embodiment 1, the recording material S can be effectively charged in the pre-charging portion N3 by suppressing that the current flows through between the secondary transfer portion N2 and the pre-charging portion N3.

TABLE 1

| CONSTITUTION | RM*¹ | STB*² | PCB*³ | SSI*⁴ | BHTI*⁵ | DR*⁶ |
|---|---|---|---|---|---|---|
| COMP. EX. 1-1 | YPI200 | −8.0 | 0 | IT | STRIPE | X |
| 1-2 | YPI200 | −6.0 | +5.5 | IT | IT | X |
| 2 | YPI200 | −5.0 | +5.0 | IT | IT | X |
| 3 | YPI200 | −6.0 | +5.5 | IT | IT | X |
| EMB. 1 | YPI200 | −6.0 | +5.5 | ◯ | ◯ | ◯ |
| 2 | YPI200 | −5.0 | +5.0 | ◯ | ◯ | ◯ |
| 3 | YPI200 | −6.0 | +5.0 | ◯ | ◯ | ◯ |

*¹: “RM” is the recording material. “YPI200” is YUPO YPI200.
*²: “STB” is the secondary transfer bias (unit: kV).
*³: “PCB” is the pre-chaning bias (unit: kV).
*⁴: “SSI” is the secondary-color solid image of magenta and cyan. “IT” represents the improper transfer.
*⁵: “BHTI” is the black halftone image. “IT” represents the improper transfer.
*⁶: “DR” is a discrimination (evaluation) result.

### OTHER EMBODIMENTS

In the above, the present invention was described in accordance with specific embodiments, but is not limited to the above-described embodiments.

In the above-described embodiments, each of the recording material charging member (pre-charging member) and the opposite member (pre-charging opposite member) was a roller-shaped member, but the present invention is not limited thereto. The recording material charging member (pre-charging member) and the opposite member (pre-charging opposite member) may also be the roller-shaped member, a brush-shaped member, a sheet-shaped member, a pod-shaped member, or the like independently of each other.

Further, in the above-described embodiments, the secondary transfer bias was subjected to the constant-voltage control, but the secondary transfer bias may also be subjected to the constant-current control.

Further, in the above-described embodiments, the recording material charging bias (pre-charging bias) was subjected to the constant-current control, but the recording material charging bias (pre-charging bias) may also be subjected to the constant-develop control.

Further, in the above-described embodiments, the image forming apparatus was the tandem image forming apparatus employing the intermediary transfer type capable of forming the full-color image. However, the image forming apparatus is not limited to the image forming apparatus capable of forming the full-color image, but may also be an image forming apparatus capable of forming only a monochromatic (white/black, monocolor) image. Further, the image forming apparatus may be image forming apparatuses for various purposes, such as printers, various printing machines, copying machines, facsimile machines, and multi-function machines.

According to the present invention, it becomes possible to effectively charge the recording material in the recording material charging portion by suppressing that the current flows through between the secondary transfer portion and the recording material charging portion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-044262 filed on Mar. 19, 2024, which is hereby incorporated by reference herein in its entirety.

What is claimed is:

1. An image forming apparatus comprising:
an image bearing member configured to bear a toner image;
an intermediary transfer belt onto which the toner image is primarily transferred from the image bearing member;
an inner roller configured to form a secondary transfer portion, where the toner image is transferred from the intermediary transfer belt onto a recording material, in contact with an inner surface of the intermediary transfer belt;
a secondary transfer member configured to form the secondary transfer portion in contact with an outer peripheral surface of the intermediary transfer belt and in cooperation with the inner roller;
a first applying portion configured to apply, to the inner roller, a secondary transfer bias of the same polarity as a normal charge polarity of toner;
a recording material charging member provided upstream of the secondary transfer portion with respect to a recording material conveying direction so as to contact a surface of the recording material on a side opposite from a surface of the recording material which is conveyed toward the secondary transfer portion and onto which the toner image is transferred and configured to charge the recording material; and
a second applying portion configured to apply, to the recording material charging member, a recording material charging bias of the same polarity as the polarity of the secondary transfer bias.

2. An image forming apparatus according to claim 1, further comprising:
a secondary transfer belt stretched by a plurality of rollers including an secondary transfer roller which is the secondary transfer member and a recording material charging roller which is the recording material charging member; and
an opposite member provided opposed to the recording material charging member and configured to form a recording material charging portion in cooperation with the recording material charging member,
wherein the secondary transfer roller forms the secondary transfer portion in contact with the inner roller through the secondary transfer belt and the intermediary transfer belt, and
the recording material charging roller forms the recording material charging portion in contact with the opposite member through the secondary transfer belt.

3. An image forming apparatus according to claim 2, wherein the opposite member is an opposite roller contacting the recording material charging roller through the secondary transfer belt.

4. An image forming apparatus according to claim 1, wherein the recording material charging member is a recording material charging roller, and the opposite member is an opposite roller contacting the recording material charging roller.

5. An image forming apparatus according to claim 4, wherein the secondary transfer member forms the secondary transfer portion in contact with the inner roller through the intermediary transfer belt.

6. An image forming apparatus according to claim 4, further comprising a secondary transfer belt stretched by a plurality of rollers including a secondary transfer roller which is the secondary transfer member,
wherein the secondary transfer roller forms the secondary transfer portion in contact with the inner roller through the secondary transfer belt and the intermediary transfer belt.

7. An image forming apparatus according to claim 1, wherein the recording material charging bias is subjected to constant-current control.

8. An image forming apparatus according to claim 1, wherein the secondary transfer bias is subjected to constant-voltage control.
